(19) United States
(12) Patent Application Publication
(10) Pub. No.: US 2008/0018422 A1
(43) Pub. Date: Jan. 24, 2008

(54) Switching Device Having an Electromagnetic Release

(75) Inventors: Patrick Claeys, Darmstadt (DE); Albrecht Vogel, Stutensee (DE); Joachim Becker, Schwetzingen (DE); Ralf Weber, Heidelberg (DE); Richard Kommert, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/664,278

(22) PCT Filed: Nov. 15, 2005
(86) PCT No.: PCT/EP05/12187

§ 371 Date: Mar. 30, 2007

(30) Foreign Application Priority Data
Nov. 22, 2004 (DE) 102004056280.6
Nov. 22, 2004 (DE) 102004056279.2

(51) Int. Cl. H01H 71/14; H01F 1/03; H01H 71/24; H01H 75/12; H01H 55/00

(52) U.S. Cl. 335/35; 335/3

(57) ABSTRACT

The invention relates to switching equipment comprising a housing, at least one contact point that has a fixed and mobile contact part and an electromagnetic trip device comprising a trip coil and a trip armature. Said equipment is wherein the trip armature is configured from a material with magnetic shape memory properties. According to the invention, when a short-circuit occurs, the trip armature is deformed by the influence of the magnetic field of the trip coil, thus causing the contact point to open.

The invention relates to a switching device having a housing and having at least one contact point, which comprises a fixed contact piece and a moveable contact piece, and having an electromagnetic release, which has a tripping coil and a tripping armature, in accordance with the precharacterizing clause of claim 1. Furthermore, the invention relates to the use of a material having a magnetic shape memory effect in an electromagnetic release, which has a tripping coil and a tripping armature, for a switching device in accordance with the precharacterizing clause of claims 18, 20 and 22.

In generic switching devices, for example line circuit breakers or motor circuit breakers, the electromagnetic release is used for interrupting the current path between the input and output terminals in the event of the occurrence of a short-circuit current. The electromagnetic releases known nowadays in the prior art, such as are described, for example, in DE 101 26 852 C1 or DE 100 10 093 A1, in this case all function on the basis of the principle that a tripping armature caused to move towards a magnet core in the event of the occurrence of a short-circuit current and, in the course of this movement, the tripping armature, via a plunger which is operatively connected to it, forces the moveable contact piece away from the fixed contact piece at the contact point, with the result that the contact point is opened. Known electromagnetic releases comprise for this purpose a coil, which is generally produced from helically wound wire, and a magnet core, which is fixedly connected to a yoke surrounding the coil on the outside and engages in the interior of the coil. The tripping armature is either in the form of a hinged armature or in the form of a plunger-type armature, the latter likewise being located within the coil. The armature is held at a distance from the core in the rest state by means of a compression spring. If the short-circuit current flows through the tripping coil, the magnetic field induced in the process in the tripping coil results in the tripping armature being moved towards the core counter to the resetting force of the compression spring. Once the short-circuit current has been switched off, the armature is moved back into its initial position again by the resetting force of the compression spring.

The design of electromagnetic releases is today very complex and associated with high costs since many individual parts need to be manufactured and assembled with exacting tolerances.

Thermal releases known in the prior art generally operate with tripping elements consisting of a bimetallic strip or thermal shape memory metals which are realized as a flexural bar or as a snap-action disk, for example. DE 43 00 909 A1 has disclosed a thermal release having a bimetallic flexural bar.

Thermal and magnetic releases are nowadays realized such that a dedicated component is manufactured for each tripping principle. In this case, a first, thermal release part having a thermal tripping armature consisting of a bimetallic strip or thermal shape memory metal, as mentioned above, and a second, magnetic release part having a tripping coil and a magnetic tripping armature are assembled. DE 42 42 516 A1 has disclosed a combined thermal and magnetic release, in the case of which the thermal release part is in the form of a snap-action disk and the electromagnetic release part is formed by an impact armature release. However, in this case too, two separate releases are constructed which are combined physically next to one another in a complex assembly.

The design of thermal and electromagnetic releases is therefore nowadays very complex and associated with high costs since two complete releases need to be constructed and combined with one another, in which case many individual parts need to be manufactured and assembled with exacting tolerances.

Residual-current circuit breakers having a modern design have an electromagnetic release, which is usually in the form of a permanent magnet release and in this case has a U-shaped magnet yoke, with which a hinged armature interacts. The hinged armature is connected, in the region of one of its ends, to one of the yoke limbs such that it can rotate, whereas the other end of the hinged armature covers the front face of the other yoke limb. The hinged armature is acted upon permanently in the opening direction by means of a spring; the yoke has an associated permanent magnet which induces a magnetic flux in the yoke which holds the armature in the position in which the armature or hinged armature covers both front faces of the yoke limbs. Furthermore, a coil is arranged on the yoke and induces a magnetic flux within the yoke in the event of the occurrence of a residual current, which magnetic flux essentially cancels the magnetic force such that the force of the spring brings the hinged armature into the open position, as a result of which a switching mechanism is actuated, with which the residual-current circuit breaker is brought into the open position. In order to avoid bonding processes between the hinged armature and the front faces of the yoke limbs, the release is inserted into a tight housing, a plunger protruding out of the housing which unlatches a switching mechanism of the residual-current circuit breaker and therefore switches the residual-current circuit breaker off.

It is therefore the object of the present invention to design a generic switching device in a manner which is simpler to fit and therefore more cost-effective.

The object is achieved for purely electromagnetic short-circuit tripping by a switching device having the characterizing features of claim 1, by the use of a material having a magnetic shape memory effect in a switching device in accordance with the characterizing features of claim 18 and by the use of a material having a magnetic shape memory effect for short-circuit current tripping in a switching device in accordance with the characterizing features of claim 20.

According to the invention, the tripping armature is therefore formed from a material having a magnetic shape memory effect, the tripping armature, under the influence of the magnetic field of the tripping coil in the event of a short-circuit current, being deformed and, as a result, the contact point being caused to open. In particular, the tripping armature may be formed from a ferromagnetic shape memory alloy consisting of nickel, manganese and gallium.

In the case of magnetic shape memory alloys, a change in shape may be brought about in the martensitic phase owing to the transition between two crystal structure variants of a twin-crystal structure, in which case the transition between the crystal structure variants is controlled by an external magnetic field. These materials are therefore referred to as magnetic shape memory alloys (MSMs).

Magnetic shape memory alloys are advantageously in the form of ferromagnetic shape memory alloys consisting of nickel, manganese and gallium. More precise explanations in relation to the design and function of ferromagnetic shape memory alloys on the basis of nickel, manganese and gallium can be gleaned, for example, from WO 98/08261 and WO 99/45631.

By means of the corresponding alloy composition it is possible to determine at which orientation of the external magnetic field the maximum expansion is achieved; for example the magnetic field may be at right angles to or transverse to the MSM material in order to reach the maximum expansion.

Changes in shape which are achieved by MSM materials under the effect of an external magnetic field may be linear expansion, bending or torsion.

The advantage of the invention consists in the fact that, in the case of a switching device according to the invention, the design of the magnetic release is significantly simplified. The magnetic release according to the invention can be realized in a more compact and space-saving manner than a magnetic release in accordance with the prior art. A switching device according to the invention having a magnetic release according to the invention can therefore also have a simpler and more compact design.

One further advantage of a switching device according to the invention is the high speed of the magnetic tripping. No inert masses need to be accelerated, and the change in shape owing to the magnetic shape memory effect takes place virtually without delay.

A further advantage is the fact that it is possible to achieve a high degree of actuating power given a relatively large change in length owing to the high degree of conversion efficiency from magnetic energy to mechanical energy in the case of ferromagnetic shape memory alloys.

In the switching device according to the invention the magnetic field can be produced for the electromagnetic tripping by a coil through which current flows.

The tripping armature consisting of a ferromagnetic shape memory metal can be in the form of an elongate component which, under the influence of the magnetic field of the tripping coil in the event of a short-circuit current, is extended in the direction of its longitudinal axis.

The tripping armature can also be in the form of a bar and, under the influence of the magnetic field of the tripping coil in the event of a short-circuit current, be bent, or the tripping armature can be helical and, under the influence of the magnetic field of the tripping coil in the event of a short-circuit current, be extended in the direction of the longitudinal axis of the helix. The magnetically induced change in shape in the martensitic phase takes place proportionally to the coil current.

One significant advantage of a switching device according to the invention consists in the very simple design of the electromagnetic release using a tripping armature consisting of a ferromagnetic shape memory metal. The release now essentially only comprises a coil and the tripping armature. The tripping armature can in this case be operatively connected, at its second end, to a plunger. However, the core and the compression spring are dispensed with in comparison to the releases in accordance with the prior art. The tripping armature according to the invention which consists of a ferromagnetic shape memory metal is also easier to mount than the tripping armature in conventional releases. This is because, in the latter case, the tripping armature needs to be mounted such that it can move easily, whereas it no longer comprises any moveable parts in the case of releases according to the invention and, in one advantageous embodiment, is mounted fixedly at a first end, in which case it expands at its second, moveable end under the influence of the magnetic field. In this case, a particularly advantageous embodiment is one in which the tripping armature is held at a first, fixed end in a mount, which is connected to the housing.

One significant advantage of a switching device according to the invention consists in the fact that the physical assignment of the tripping coil to the tripping armature consisting of a ferromagnetic shape memory metal can be matched in a variety of ways to the geometrical requirements within the switching device housing. In one advantageous embodiment the tripping armature can be surrounded by the tripping coil. In accordance with a further advantageous embodiment the tripping armature can be fitted outside the coil in its vicinity.

Optimum utilization of space can therefore be achieved within the switching device housing, which results in smaller and therefore more cost-effective designs of the switching devices.

Fewer parts are required with a lower demand on their measurement accuracy for the electromagnetic release, and it is therefore simpler and less expensive to fit an electromagnetic release with a tripping armature consisting of a ferromagnetic shape memory metal.

A very similar design as in the case of a release for short-circuit tripping can also be applied in the case of a residual-current circuit breaker. In this case, the component consisting of the material having a magnetic shape memory effect acts directly on a switching mechanism, to which a contact lever of the residual-current circuit breaker is coupled. The essential considerations arising in the case of a release for short circuits also apply in a corresponding manner to the release of a residual-current circuit breaker, it only being necessary to take care that the voltage or energy applied to the coil as the secondary voltage is relatively low.

The object is further achieved by a switching device having the characterizing features of claims 1 and 2, by the use of a material having a combined thermal and magnetic shape memory effect in a switching device in accordance with the characterizing features of claim 12 and by the use of a material having a combined thermal and magnetic shape memory effect for short-circuit current and overcurrent tripping in a switching device in accordance with the characterizing features of claim 14.

According to the invention, the tripping armature is therefore formed from a material having a combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open. In particular, the tripping armature can be formed from a ferromagnetic shape memory alloy consisting of nickel, manganese and gallium.

In the case of magnetic shape memory alloys, a change in shape may be brought about in the martensitic phase owing to the transition between two crystal structure variants of a twin-crystal structure, in which case the transition between the crystal structure variants is controlled by an external magnetic field. These materials are therefore referred to as magnetic shape memory alloys (MSMs).

Magnetic shape memory alloys are advantageously in the form of ferromagnetic shape memory alloys consisting of nickel, manganese and gallium. More precise explanations in relation to the design and operation of ferromagnetic shape memory alloys on the basis of nickel, manganese and gallium can be gleaned, for example, from WO 98/08261 and WO 99/45631.

Further advantageous refinements and improvements of the invention and further advantages are given in the further dependent claims.

The invention and further advantageous refinements of the invention will be explained and described in more detail with reference to the drawings, in which five exemplary embodiments of the invention are illustrated and in which:

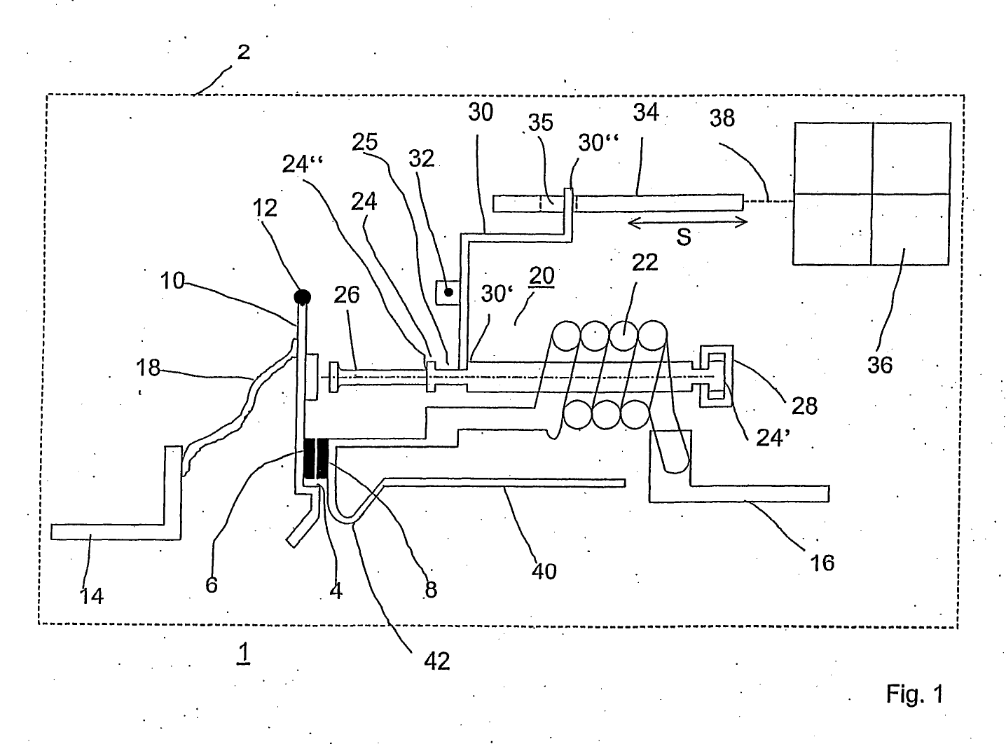

FIG. 1 shows a schematic illustration of a first embodiment of a switching device according to the invention having a rod-shaped tripping armature consisting of a ferromagnetic shape memory metal, arranged in the interior of a tripping coil, in the rest state,

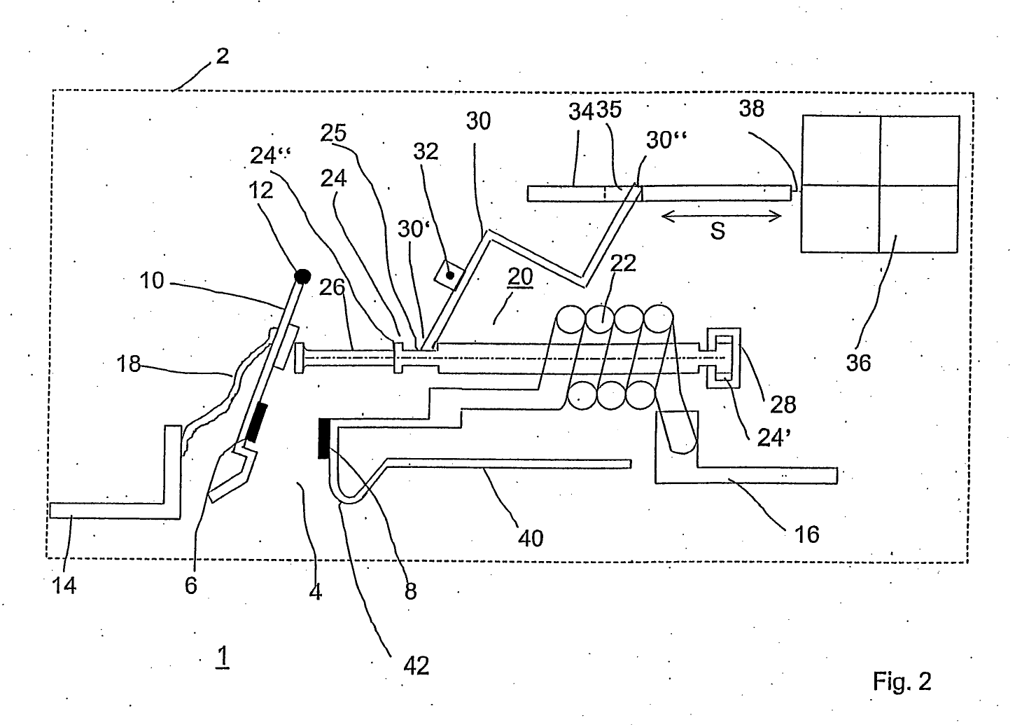

FIG. 2 shows a schematic illustration of the first embodiment shown in FIG. 1 in the tripped state,

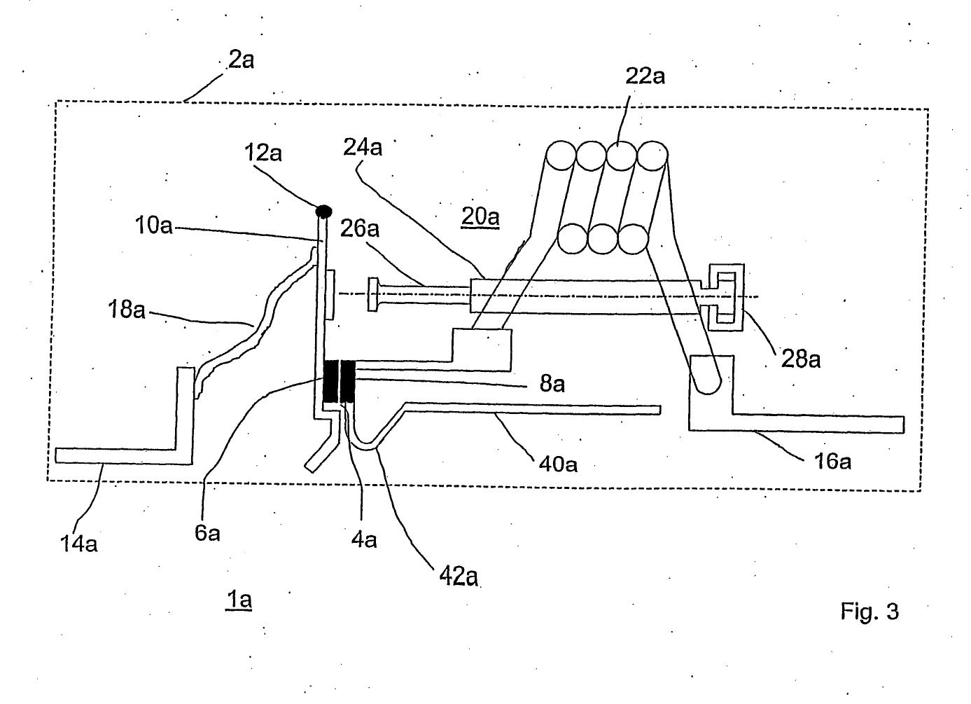

FIG. 3 shows a schematic illustration of a second embodiment of a switching device according to the invention having a rod-shaped tripping armature consisting of a ferromagnetic shape memory metal, arranged adjacent to a tripping coil, in the rest state,

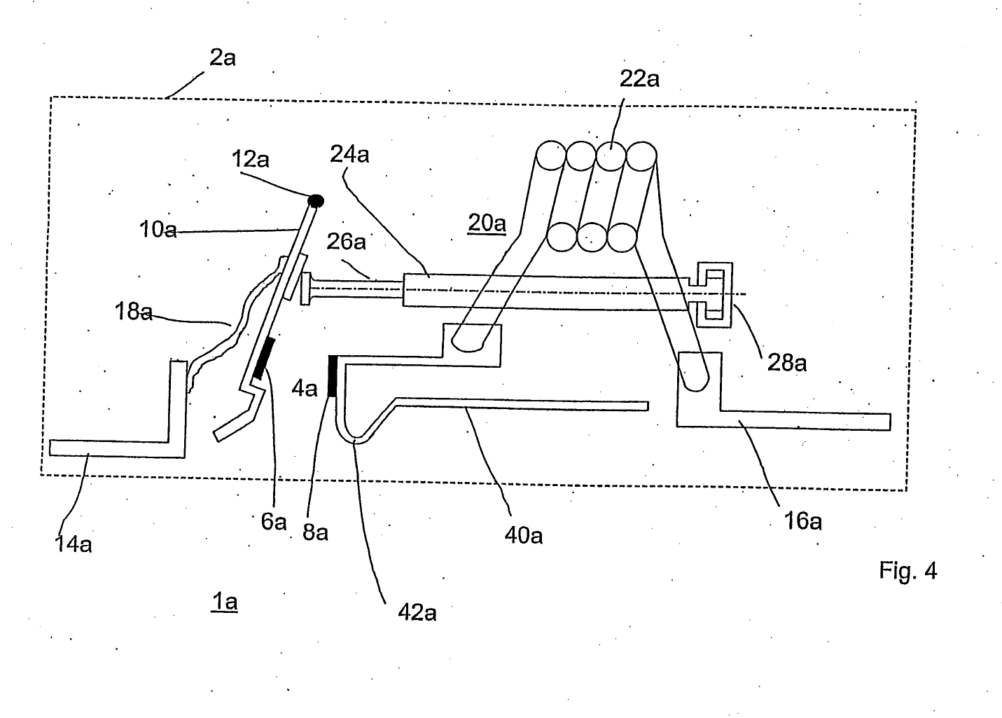

FIG. 4 shows a schematic illustration of the second embodiment shown in FIG. 3 in the tripped state,

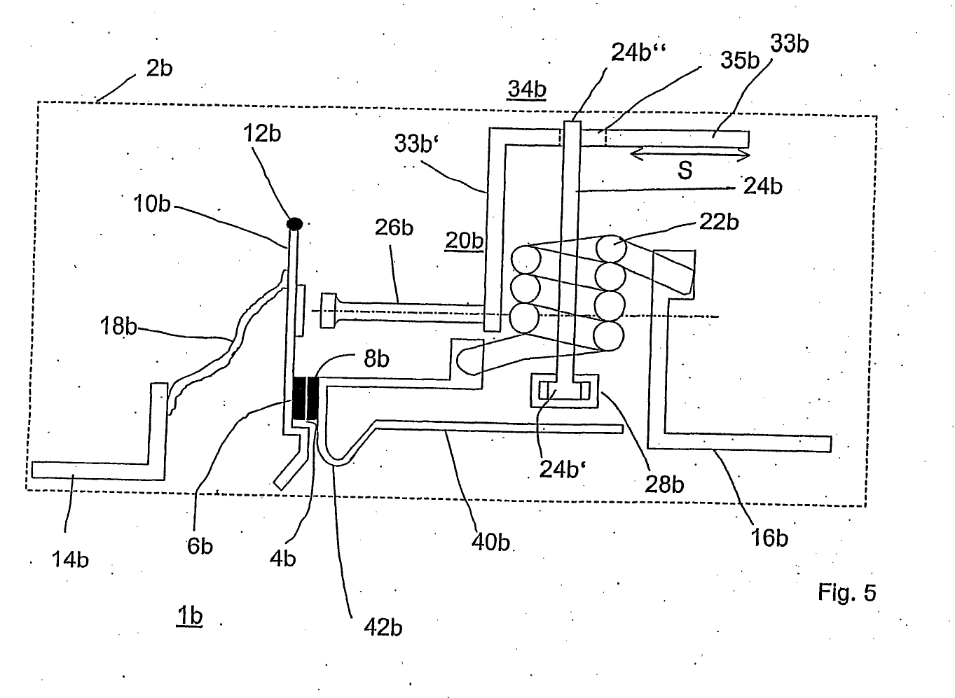

FIG. 5 shows a schematic illustration of a third embodiment of a switching device according to the invention having a tripping armature which is in the form of a flexural bar clamped in at one end, consists of a ferromagnetic shape memory metal and is arranged in the interior of a tripping coil, in the rest state,

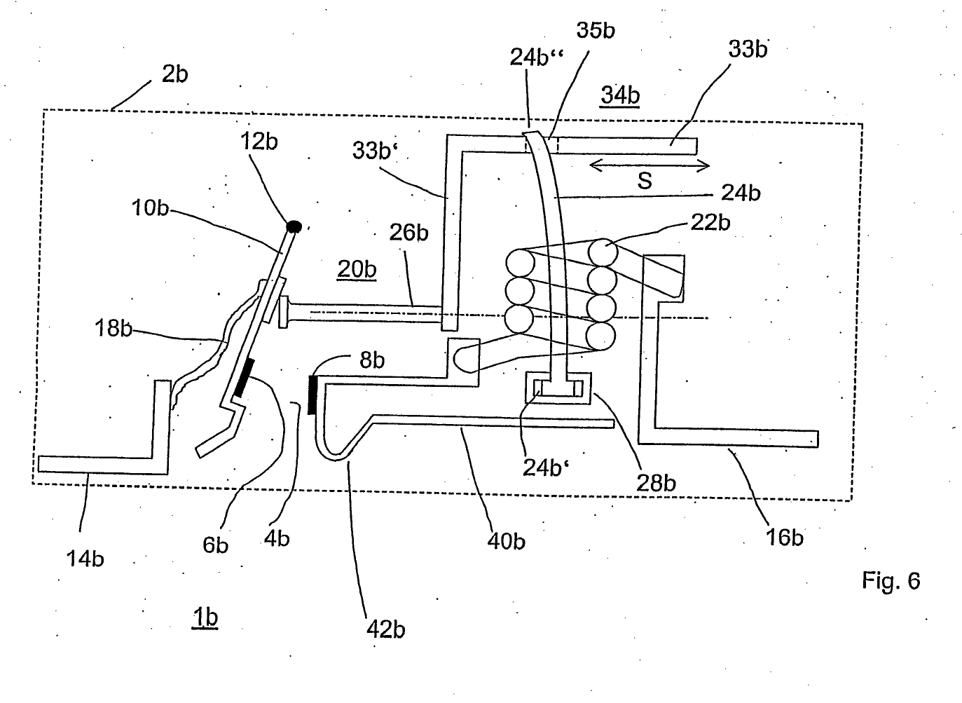

FIG. 6 shows a schematic illustration of the third embodiment shown in FIG. 5 in the tripped state,

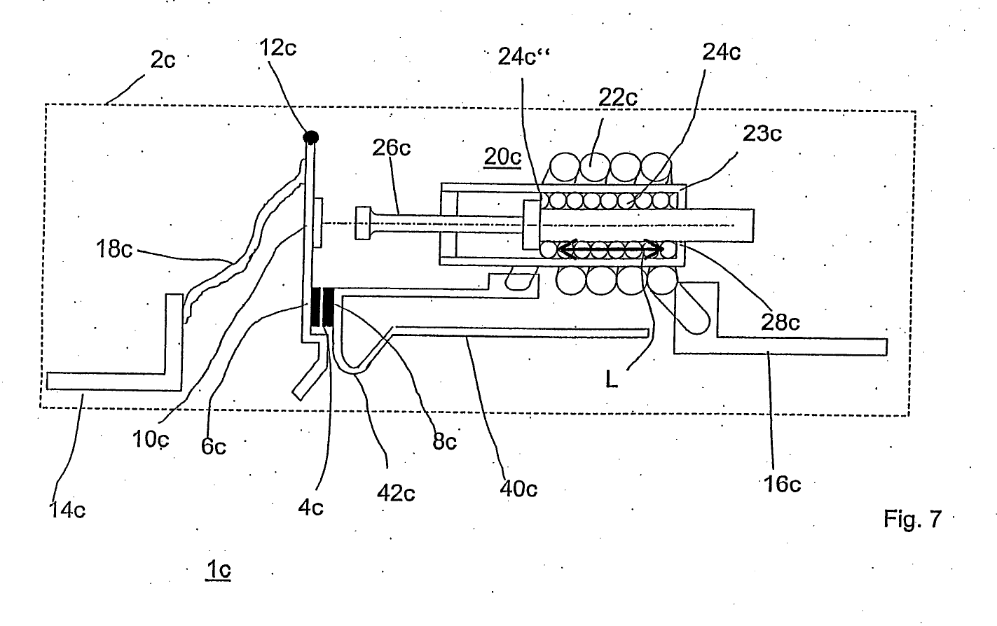

FIG. 7 shows a schematic illustration of a fourth embodiment of a switching device according to the invention having a tripping armature consisting of a ferromagnetic shape memory metal in the form of a helix, arranged in the interior of a tripping coil, in the rest state,

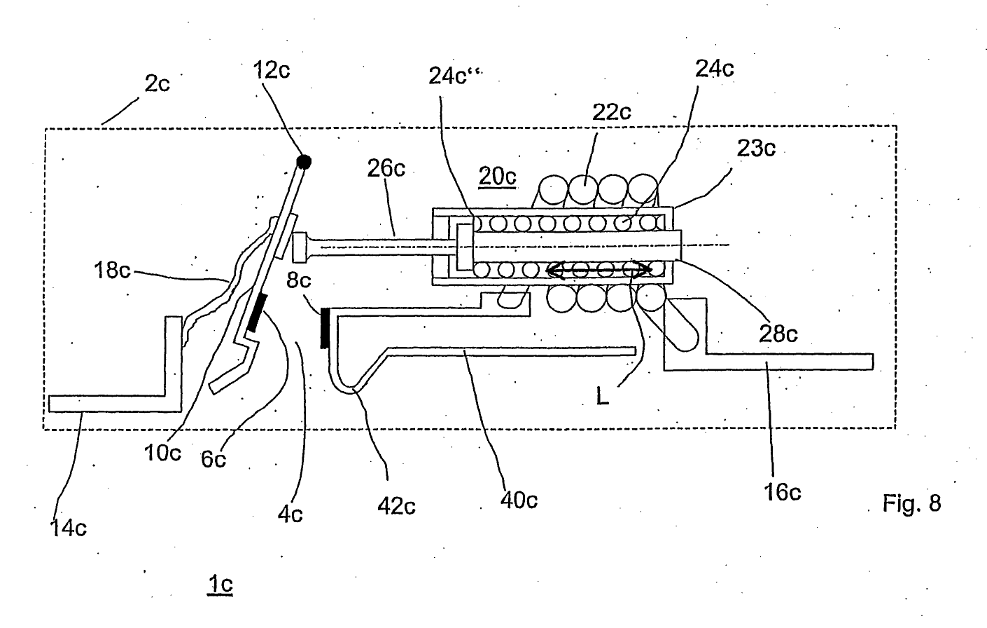

FIG. 8 shows a schematic illustration of the fourth embodiment shown in FIG. 7 in the tripped state,

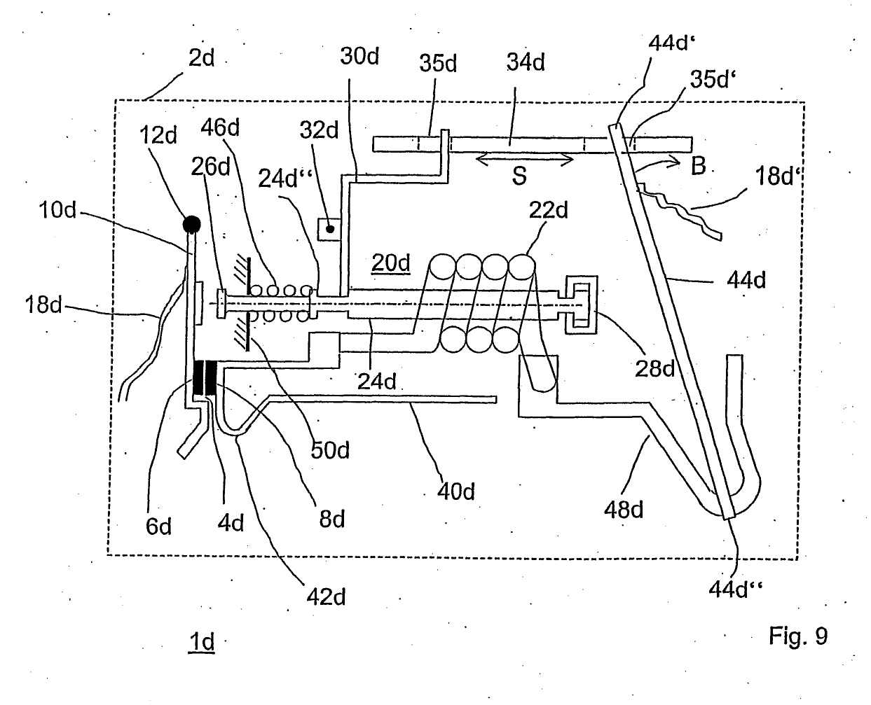

FIG. 9 shows a schematic illustration of a fifth embodiment of a switching device according to the invention having a rod-shaped tripping armature consisting of a ferromagnetic shape memory metal, arranged in the interior of a tripping coil, and having a thermal release consisting of a bimetallic strip, in the rest state,

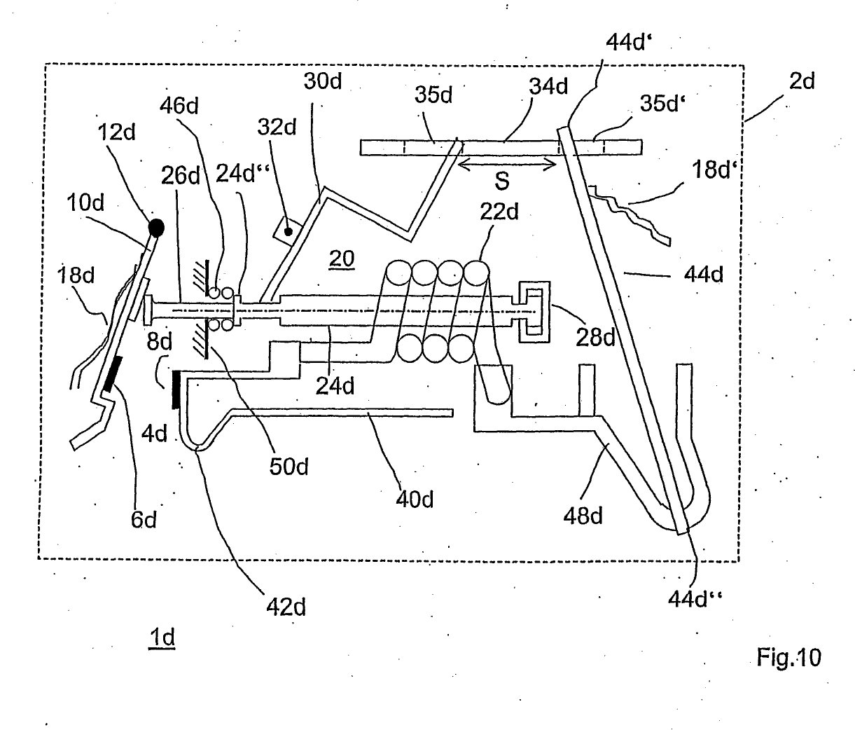

FIG. 10 shows a schematic illustration of the fifth embodiment shown in FIG. 9 in the tripped state,

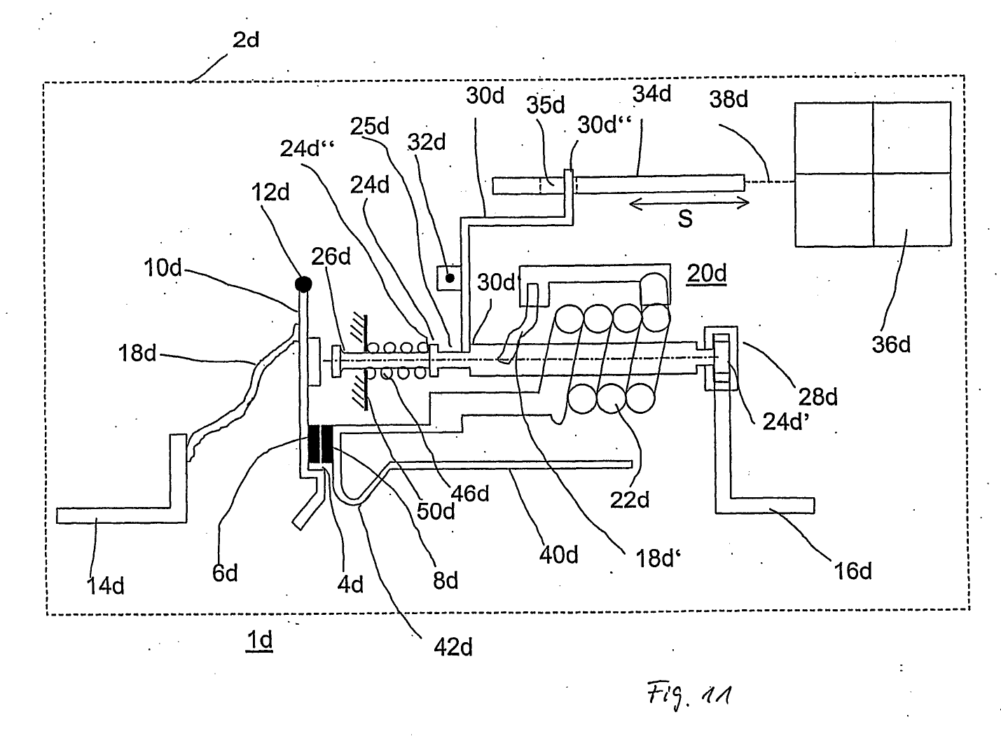

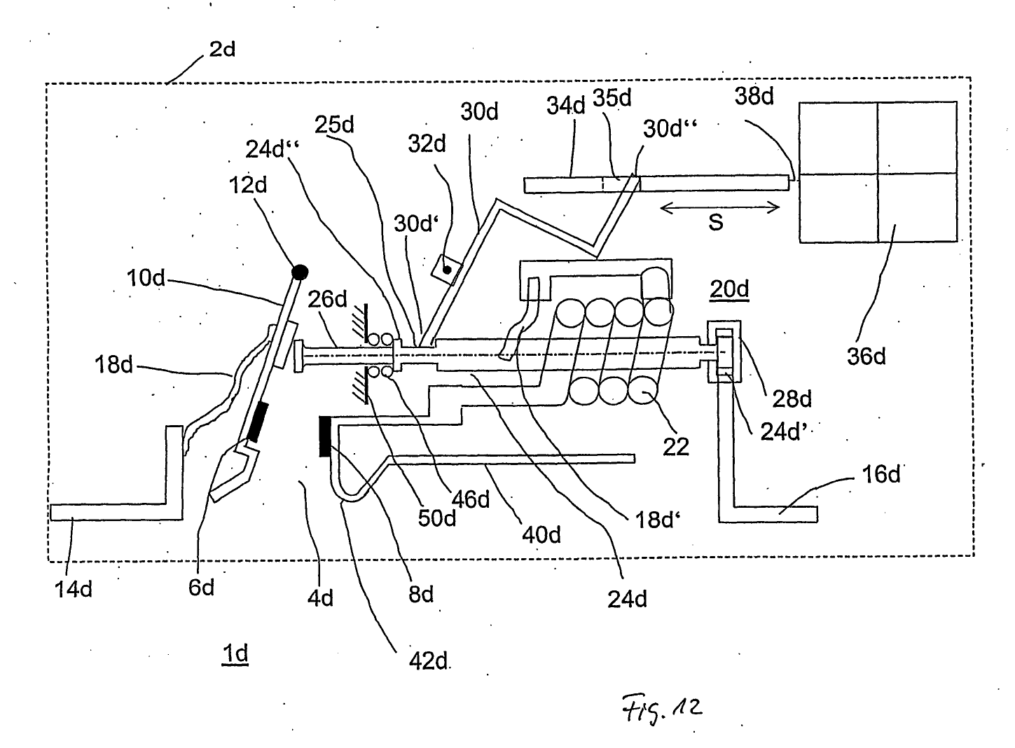

FIGS. 11 and 12 show a sixth embodiment in the untripped and tripped state, and

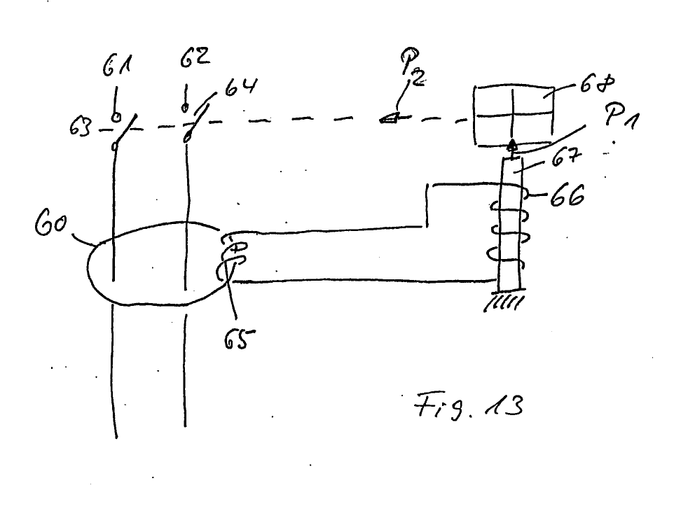

FIG. 13 shows a schematic illustration of a residual-current circuit breaker.

FIG. 1 shows a schematic illustration of a switching device 1 having a housing 2, an electromagnetic release 20 and a switching mechanism 36 in the untripped state.

FIG. 2 shows the switching device shown in FIG. 1 in the tripped state, in which case identical or functionally similar modules or parts are denoted by the same reference numerals.

A current path runs between an input clamping piece 14 and an output clamping piece 16 via a moveable braided wire 18, a contact lever 10 mounted in a contact-lever mount 12, a contact point 4 comprising a moveable contact piece 6 located on the contact lever 10 and a fixed contact piece 8, and a tripping coil 22. In the switching position shown in FIG. 1, the contact point 4 is closed. A yoke 40 is also connected to the tripping coil 22 and the fixed contact piece 8 via a lug-shaped intermediate piece 42.

Not illustrated is a thermal release which is also contained in some switching devices and acts on the switching mechanism in the event of the occurrence of an overcurrent, with the result that said switching mechanism then permanently opens the contact point.

The electromagnetic release 20 comprises the tripping coil 22 and a tripping armature 24, which in this case is in the form of a bar and is arranged in the interior of the tripping coil 22 such that the longitudinal axis of the coil and the longitudinal axis of the tripping armature coincide.

At a first, fixed end 24′, the tripping armature 24 is held in a tripping-armature mount 28, which is connected to the housing 2. At its second, free end 24″, the tripping armature 24 is operatively connected to a plunger 26. The operative connection is shown here as an interlocking connection, but force-fitting connections or connections produced by techniques such as soldering, bonding or welding could also alternatively be realized.

At its free end 24″, the tripping armature 24 has a notch 25 in which a tripping lever 30, which is mounted in a tripping-lever mount 32, engages, for example with a fork located at its first free end 30′. The second free end 30″ of the tripping lever 30 engages in a cutout 35 in a slide 34, which is operatively connected to the switching mechanism 36 via a line of action 38. The tripping armature 24 consists of a ferromagnetic shape memory alloy based on nickel, manganese and gallium. Such ferromagnetic shape memory alloys are known in principle and are available; they are produced and marketed, for example, by the Finnish firm AdaptaMat Ltd. A typical composition of ferromagnetic shape memory alloys for the use according to the invention in switching devices is provided by the structural formula Ni_{65-x-y}Mn₂₀₊ₓGa_{15+y}, where x is between 3 atomic percent and 15 atomic percent, and y is between 3 atomic percent and 12 atomic percent. The ferromagnetic shape memory alloy used here has the property that, in its martensitic phase, that is the phase which the material assumes below the thermal transition temperature, under the influence of an external magnetic field on a microscopic scale a transition between two crystal structure variants of a twin-crystal structure takes place which is macroscopically connected to a change in shape. In the embodiment selected here for the tripping armature, the change in shape consists in a linear extension in the direction of the longitudinal axis of the bar.

The thermal transition temperature in the case of the ferromagnetic shape memory alloys used here is in the region of the ambient temperature and can be adjusted by varying the atomic percent proportions x and y within a bandwidth. The working temperature range within which the electromagnetic release operates can therefore be adjusted within a bandwidth by selecting the material composition.

If a high short-circuit current flows through the switching device 2 in the event of a short circuit, the tripping armature 24 expands owing to the above-described effect and, as a result, the plunger 26 forces the moveable contact piece 6 away from the fixed contact piece 8, with the result that the contact point 4 is opened and the switching device is tripped, as illustrated in FIG. 2. The expansion of the ferromagnetic shape memory material takes place in this case very rapidly and virtually without any delay. The delay time as the time difference between the occurrence of the short-circuit current and the maximum length expansion of the tripping armature 24 is typically of the order of magnitude of one millisecond.

Tripping is in this case assisted by the tripping lever 30, which rotates in the clockwise direction about the tripping-lever mount 32 when the tripping armature 24 expands and in the process displaces the slide 34 in the direction of its longitudinal extent, indicated by the directional arrow S, with the result that the slide 34 actuates the switching mechanism 36 via the line of action 38.

Once the switching device has been tripped, the current path is interrupted and the magnetic field of the tripping coil 22 breaks down again. As a result, the tripping armature 24 will again contract to its initial dimensions, as a result of which the tripping lever 30 is also moved back into the initial position again, as shown in FIG. 1. The contact point 4 is now held permanently in the open position by the switching mechanism 36 owing to the lines of action (not illustrated here).

FIG. 3 shows a further embodiment of a switching device 1a according to the invention in the untripped state, and FIG. 4 shows the switching device 1a in the tripped state. Identical or functionally identical components and parts are denoted by the same reference numerals as in FIGS. 1 and 2, supplemented by the letter a. The essential difference between the switching device 1a shown in FIGS. 3 and 4 and the switching device 1 shown in FIGS. 1 and 2 consists in the fact that, in the former case, the tripping armature 24a consisting of the ferromagnetic shape memory alloy based on NiMnGa is arranged outside the tripping coil 22a. In addition, the tripping lever 30a, the slide 34a and the switching mechanism 36a are not illustrated in FIGS. 3 and 4 for reasons of clarity. In the event of a short-circuit, the change in shape of the tripping armature 24a in the embodiment shown in FIGS. 3 and 4 is brought about by the magnetic field in the outer region of the tripping coil 22a. A corresponding design of the tripping coil 22a and the magnetic circuit can be carried out by a person skilled in the art using his normal knowledge in the art and assisted by systematic experiments.

FIG. 5 shows a further embodiment of a switching device 1b according to the invention in the untripped state, and FIG. 6 shows the switching device 1b in the tripped state. Identical or functionally identical components and parts are denoted by the same reference numerals as in the case of the switching device 1 in FIGS. 1 and 2, supplemented by the letter b. The essential difference between the switching device 1b shown in FIGS. 5 and 6 and the switching device 1 shown in FIGS. 1 and 2 consists in the fact that, in the former case, the tripping armature 24b is in the form of a flexural bar, which is clamped in fixedly, with a first, fixed end 24b′, at one end at the tripping armature bearing point 28b. The tripping armature 24b is arranged in the interior of the tripping coil 22b. The change in shape induced by the magnetic field of the tripping coil 22b in the event of a short circuit in this case consists in bending of the tripping armature 24b at its second, free end 24b″, see FIG. 6. The second, free end 24b″ of the tripping armature 24b engages in a cutout 35b in a first limb 33b of the L-shaped slide 34b, as a result of which said slide is displaced when the tripping armature 24b is bent in the direction of the longitudinal extent of the first limb 33b, indicated by the directional arrow S. At its second limb 33b′, the slide 34b is operatively connected to the plunger 26b, which forces the moveable contact 6b away from the fixed contact 8b when the slide 34b is displaced and thus opens the contact point 4b. The switching mechanism 36 is not illustrated in the embodiment in FIGS. 5 and 6 for reasons of clarity.

FIG. 7 shows a further embodiment of a switching device 1c according to the invention in the untripped state, and FIG. 8 shows the switching device 1c in the tripped state. Identical or functionally identical components and parts are denoted by the same reference numerals as in the case of the switching device 1 in FIGS. 1 and 2, supplemented by the letter c. The essential difference between the switching device 1c shown in FIGS. 7 and 8 and the switching device 1 shown in FIGS. 1 and 2 consists in the fact that, in the former case, the tripping armature 24c is helical and is guided in the interior of the tripping coil 24c in a guide sleeve 23c, which is aligned parallel to the axis of the coil. The change in shape of the helical tripping armature 24c induced by the magnetic field of the tripping coil 22c in the event of a short circuit in this case consists in an expansion of the helix 24c, which forms the tripping armature, in the direction of the longitudinal axis of the helix, indicated by the directional arrow L. At the moveable end 24c″ of the helical tripping armature 24c, it is operatively connected to the plunger 26c, which, in the event of tripping, opens the contact point 4c, see FIG. 8.

FIG. 9 shows a further embodiment of a switching device 1d according to the invention in the untripped state, and FIG. 10 shows the switching device 1d in the tripped state. Identical or functionally identical components and parts are denoted by the same reference numerals as in the case of the switching device 1 in FIGS. 1 and 2, supplemented by the letter d.

The electromagnetic release 20d in the embodiment as shown in FIGS. 9 and 10 is constructed as the electromagnetic release 20 in FIGS. 1 and 2. The input terminals and output terminals as well as the switching mechanism are not illustrated in the embodiment shown in FIGS. 9 and 10 for reasons of clarity. The switching device 1d in the embodiment shown in FIGS. 9 and 10 also comprises a thermal overcurrent release in addition to the electromagnetic release 20d. This overcurrent release is essentially formed from a bimetallic strip 44d, which is fixed with its first, fixed end 44d″ to a bimetallic holder 48d, and whose second, moveable end 44d′ engages in a further cutout 35d′ in the slide 34d. In this case, the current path extends from the input terminal (not illustrated) via a first moveable braided wire 18d, the contact lever 10d, the contact point 4d formed from the moveable and the fixed contact piece 6d, 8d, the tripping coil 22d, the bimetallic holder 48d, the bimetallic strip 44d, a second moveable braided wire 18d′ to the output terminal (not illustrated).

In the event of an overcurrent, the bimetallic strip 44d bends in the direction indicated by the directional arrow B, with the result that the slide 34d is displaced in the direction of its longitudinal axis, indicated by the directional arrow S, and, via a line of action (not illustrated here), interacts with the switching mechanism (likewise not illustrated here), which then permanently opens the contact point 4d. In the event of a short-circuit current, tripping by means of the electromagnetic release 20d takes place as already described for FIGS. 1 and 2.

In order to assist in the back-deformation of the tripping armature 24d once the magnetic field of the tripping coil 22s has broken down as a result of the contact opening in the event of tripping, in the embodiment shown in FIGS. 9 and 10 a resetting spring 46d is provided. In this case, this resetting spring is in the form of a helical spring and surrounds the plunger 26d. However, it could also be in the form of a leaf spring or have another suitable design. The resetting spring is unstressed in the untripped state (FIG. 9). It is supported with one end on a spring mount 50d, which is connected to the housing, and with its other end on the moveable end 24d″ of the tripping armature 24d. In the event of tripping (FIG. 10), it is compressed by the expanding tripping armature 24d.

The exemplary embodiments described and illustrated in FIGS. 1 to 10 are an exemplary non-exclusive representation of possible switching devices according to the invention using an electromagnetic release having a tripping armature consisting of a ferromagnetic shape memory alloy. It is also possible for switching devices according to the invention to be produced from all other switching device variants known in the prior art having electromagnetic releases by the use according to the invention of a ferromagnetic shape memory alloy for forming the tripping armature.

The embodiments shown in FIGS. 1 to 10 have been explained essentially for materials in the case of which only the magnetic shape memory effect occurs. Completely the same, identical construction can then also be used if materials are used which have both a magnetic and a thermal shape memory effect. In particular in this case, as far as FIGS. 9 and 10 are concerned, a particularly advantageous embodiment is provided in so far as the bimetallic strip 44d can be dispensed with entirely and only the tripping armature 24d is used for both electromagnetic and thermal tripping.

The embodiment shown in FIG. 9 differs from that shown in FIG. 1 by virtue of the fact that, in the former case, heating of the tripping armature 24d takes place directly by current flow and not, as in the latter case, indirectly via thermal radiation from the tripping coil 22d. The current path in the embodiment shown in FIG. 9 is as follows: the current flows from the input terminal 14d via the moveable braided wire 18d, the contact lever 10d, the contact point 4d through the tripping coil 22d and on in series with this via a further moveable braided wire 18d′, which connects the end of the tripping coil 22d electrically to the front part of the tripping armature 24d, through said tripping armature 24d and from its fixed end 24d′ on to the output terminal 16d. In the event of an overcurrent, the tripping armature 24d is therefore heated directly by Joulean heat. As a result, a thermally more precise design of the thermal and magnetic release 20d is possible.

In order to assist in the back-deformation of the tripping armature 24d after tripping—in the event of a short-circuit current once the magnetic field of the tripping coil 22d has broken down or in the event of an overcurrent once the tripping armature 24d has been cooled to a temperature below the thermal transition temperature as a result of the contact opening—in the embodiment shown in FIGS. 9 and 10 a resetting spring 46d is provided. In this case, this resetting spring is in the form of a helical spring and surrounds the plunger 26d. However, it could also be in the form of a leaf spring or have another suitable design. The resetting spring is unstressed in the untripped state (FIG. 9). It is supported with one end on a spring mount 50d, which is connected to the housing, and with its other end on the moveable end 24d″ of the tripping armature 24d. In the event of tripping (FIG. 10), it is compressed by the expanding tripping armature 24d.

The exemplary embodiments described and illustrated in FIGS. 1 to 10 are an exemplary, non-exclusive representation of possible switching devices according to the invention using a thermal and electromagnetic release having a tripping armature consisting of a ferromagnetic shape memory alloy. It is also possible for switching devices according to the invention to be produced from all other switching device variants known in the prior art having thermal and electromagnetic releases by the use according to the invention of a ferromagnetic shape memory alloy for forming the tripping armature.

The embodiment shown in FIG. 11 differs from that shown in FIG. 1 by virtue of the fact that, in the former case, heating of the tripping armature 24d takes place directly by current flow and not, as in the latter case, indirectly via thermal radiation from the tripping coil 22d. The current path in the embodiment shown in FIG. 9 is as follows: the current flows from the input terminal 14d via the moveable braided wire 18d, the contact lever 10d, the contact point 4d through the tripping coil 22d and on in series with this via a further moveable braided wire 18d′, which connects the end of the tripping coil 22d electrically to the front part of the tripping armature 24d, through said tripping armature 24d and from its fixed end 24d′ on to the output terminal 16d. In the event of an overcurrent, the tripping armature 24d is therefore heated directly by Joulean heat. As a result, a thermally more precise design of the thermal and magnetic release 20d is possible.

In order to assist in the back-deformation of the tripping armature 24d after tripping—in the event of a short-circuit current once the magnetic field of the tripping coil 22d has broken down or in the event of an overcurrent once the tripping armature 24d has been cooled to a temperature below the thermal transition temperature as a result of the contact opening—in the embodiment shown in FIGS. 9 and 10 a resetting spring 46d is provided. In this case, this resetting spring is in the form of a helical spring and surrounds the plunger 26d. However, it could also be in the form of a leaf spring or have another suitable design. The resetting spring is unstressed in the untripped state (FIG. 9). It is supported with one end on a spring mount 50d, which is connected to the housing, and with its other end on the moveable end 24d″ of the tripping armature 24d. In the event of tripping (FIG. 12), it is compressed by the expanding tripping armature 24d.

The exemplary embodiments described and illustrated in FIGS. 1 to 12 are an exemplary, non-exclusive representation of possible switching devices according to the invention using a thermal and electromagnetic release having a tripping armature consisting of a ferromagnetic shape memory alloy. It is also possible for switching devices according to the invention to be produced from all other switching device variants known in the prior art having thermal and electromagnetic releases by the use according to the invention of a ferromagnetic shape memory alloy for forming the tripping armature.

Reference will now briefly be made to FIGS. 1 and 2. These figures show a switching device which is designed for a short-circuit current. As can be seen here, the movement of the armature 24, which can also be referred to as a plunger, is transferred to the contact lever 10. Furthermore, the movement of the plunger 24 is also transferred to the switching mechanism 36 via the lever mechanism 30 and the slide 34. If the switch shown in FIG. 1 is intended to be modified, merely for tripping purposes in the event of a residual current, the coil 22 is connected to the so-called primary winding in the residual-current circuit breaker and the plunger 26 is omitted, with the result that it is not the rated current but the secondary current that flows through the coil 22; the movement of the plunger 24 then leads, for example, to the switching mechanism via the components 30 and 34. It is naturally also possible to arrange the plunger 24 such that it acts directly on the switching mechanism 36.

A schematic illustration of this arrangement is shown in FIG. 13. Primary conductors 61 and 62 are passed through a transformer core 60, said conductors having contact points 63 and 64. A secondary winding 65 is arranged around the transformer core 60 and is connected to a coil 66, in which a plunger 67 consisting of a material having a magnetic, but possibly also having a magnetic and a thermal shape memory effect is passed through. This plunger 67 acts, as shown by arrow direction P1, on a switching mechanism 68 and, once it has been unlatched, the switching mechanism acts on the contact points 63, 64 in accordance with the arrow direction P2. In comparison with the arrangement shown in FIG. 1, the plunger 67 has the reference numeral 24 in FIG. 1, the switching mechanism 68 has the reference numeral 36 in FIG. 1, and the coil 66 has the reference numeral 22 in the arrangement shown in FIG. 1, and, as can be seen, a plunger element 26 is missing because it is not conventional for there to be direct action on the contact points 63, 64 in such a residual-current circuit breaker.

### LIST OF REFERENCE SYMBOLS

1, 1a, 1b, 1c, 1d Switching device
2, 2a, 2b, 2c, 2d Housing
4, 4a, 4b, 4c, 4d Contact point
6, 6a, 6b, 6c, 6d Moveable contact piece
8, 8a, 8b, 8c, 8d Fixed contact piece
10, 10a, 10b, 10c, 10d Contact lever
12, 12a, 12b, 12c, 12d Contact-lever mount
14, 14a, 14b, 14c Input terminal
16, 16a, 16b, 16c Output terminal
18, 18a, 18b, 18c, Moveable braided wire 18d, 18d′
20, 20a, 20b, 20c, 20d Electromagnetic release
22, 22a, 22b, 22c, 22d Tripping coil
23c Guide sleeve
24, 24a, 24b, 24c, 24d Tripping armature
24′, 24b′ Fixed end of the tripping armature
24″, 24b″, 24c″, Moveable end of the tripping
24d″ armature
25 Notch
26, 26a, 26b, 26c, 26d Plunger
28, 28a, 28b, 28c, 28d Tripping-armature mount
30 Tripping lever
30′ First free end of the tripping lever
30″ Second free end of the tripping lever
32, 32d Tripping-lever mount
33b First limb of the slide 34b
33b′ Second limb of the slide 34b
34, 34b, 34d Slide
35, 35b, 35d, 35d′ Cutout in the slide
36 Switching mechanism
38 Line of action
40, 40a, 40b, 40c, 40d Yoke
42, 42a, 42b, 42c, 42d Intermediate piece
44d Bimetallic strip
44d′ Moveable end of the bimetallic strip
44d″ Fixed end of the bimetallic strip
46d Resetting spring
48d Bimetallic holder
50d Spring mount
S, L, B Directional arrow

1. A switching device having a housing and having at least one contact point, which comprises a fixed and a moveable contact piece, and having an electromagnetic release, which has a tripping coil and a tripping armature, wherein the tripping armature is formed from a material having at least a magnetic shape memory effect, the tripping armature, under the influence of the magnetic field of the tripping coil in the event of a short-circuit current and/or in the event of a residual current, being deformed and, as a result, the contact point being caused to open.

2. The switching device as claimed in claim 1, wherein, in addition to the magnetic shape memory effect, the material also has a thermal shape memory effect, with the result that the tripping armature is deformed, both under the influence of the magnetic field and under the influence of increased temperature.

3. The switching device as claimed in claim 1, wherein the tripping armature is formed from a ferromagnetic shape memory alloy consisting of nickel, manganese and gallium.

4. The switching device as claimed in, claim 1, wherein the tripping armature is in the form of an elongate component and, under the influence of the magnetic field of the tripping coil in the event of a short-circuit current and/or in the event of a residual current, is extended in the direction of its longitudinal axis.

5. The switching device as claimed in claim 1, wherein the tripping armature is in the form of a bar and, under the influence of the magnetic field of the tripping coil in the event of a short-circuit current and/or in the event of a residual current, is bent.

6. The switching device as claimed in claim 1, wherein the tripping armature is helical and, under the influence of the magnetic field of the tripping coil in the event of a short-circuit current and/or in the event of a residual current, is extended in the direction of the longitudinal axis of the helix.

7. The switching device as claimed in claim 1, wherein the tripping armature is surrounded by the tripping coil.

8. The switching device as claimed in claim 1, wherein the tripping armature is fitted outside the tripping coil in its vicinity.

9. The switching device as claimed in claim 1, wherein the tripping armature is in the form of an elongate component and, both under the influence of the magnetic field of the tripping coil in the event of a short-circuit current and under the influence of an increase in temperature brought about by overcurrent, is extended in the direction of its longitudinal axis.

10. The switching device as claimed in claim 1, wherein the tripping armature is in the form of a bar and, both under the influence of the magnetic field of the tripping coil in the event of a short-circuit current and under the influence of an increase in temperature brought about by overcurrent, is bent.

11. The switching device as claimed in claim 1, wherein the tripping armature is helical and, both under the influence of the magnetic field of the tripping coil in the event of a short-circuit current and under the influence of an increase in temperature brought about by overcurrent, is extended in the direction of the longitudinal axis of the helix.

12. The switching device as claimed in claim 1, wherein the tripping armature is surrounded by the tripping coil.

13. The switching device as claimed in claim 1, wherein the tripping armature is fitted outside the tripping coil in its vicinity.

14. The switching device as claimed in claim 1, wherein the increase in temperature of the tripping armature in the event of an overcurrent is brought about by means of indirect heating by the tripping coil carrying the overcurrent.

15. The switching device as claimed in claim 1, wherein the increase in temperature of the tripping armature in the event of an overcurrent is brought about by means of direct heating owing to the overcurrent flowing through the tripping armature.

16. The switching device as claimed in claim 1, wherein the tripping armature is held at a first end in a mount, which is connected to the housing.

17. The switching device as claimed in, claim 1, wherein the tripping armature is operatively connected at its second end to a plunger.

18. The use of a material having a magnetic shape memory effect in an electromagnetic release, which has a tripping coil and a tripping armature, for a switching device, wherein the tripping armature of the release is formed from the material having a magnetic shape memory effect, the tripping armature, under the influence of the magnetic field of the tripping coil in the event of a short-circuit current and/or in the event of a residual current, being deformed and, as a result, a contact point being caused to open.

19. The use of a material having a magnetic shape memory effect as claimed in claim 10, wherein a ferromagnetic shape memory alloy consisting of nickel, manganese and gallium is used.

20. The use of a material having a magnetic shape memory effect for short-circuit current tripping in a switching device, which comprises a contact point and an electromagnetic release, wherein the tripping armature of the electromagnetic release, which has a tripping coil and a tripping armature, is formed from the material having a magnetic shape memory effect, the tripping armature, under the influence of the magnetic field of the tripping coil in the event of a short-circuit current and/or in the event of a residual current, being deformed and, as a result, a contact point being caused to open.

21. The use of a material having a magnetic shape memory effect for short-circuit current tripping as claimed in claim 20, consisting of a ferromagnetic shape memory alloy consisting of nickel, manganese and gallium.

22. The use of a material having a combined thermal and magnetic shape memory effect in a thermal and magnetic release, which comprises a tripping coil and a tripping armature, for a switching device, wherein the tripping armature of the release is formed from the material having the combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open.

23. The use of a material having a combined thermal and magnetic shape memory effect as claimed in claim 22, consisting of a ferromagnetic shape memory alloy consisting of nickel, manganese and gallium.

24. The use of a material having a combined thermal and magnetic shape memory effect for short-circuit current and overcurrent tripping in a switching, which comprises a contact point and a thermal and magnetic release, wherein the tripping armature of the release, which has a tripping coil and a tripping armature, is formed from the material having the combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open.

25. The use of a material having a combined thermal and magnetic shape memory effect for short-circuit current and overcurrent tripping as claimed in claim 14, consisting of a ferromagnetic shape memory alloy consisting of nickel, manganese and gallium.
